(19) United States
(12) Patent Application Publication
(10) Pub. No.: US 2006/0168856 A1
(43) Pub. Date: Aug. 3, 2006

(54) Hinge mounted light and sign assembly

(76) Inventor: Raymond D. Laughlin, Milan, IL (US)

Correspondence Address: LAW OFFICE OF JAY R. HAMILTON, PLC., 331 W. 3RD ST., NEW VENTURES CENTER SUITE 100, DAVENPORT, IA, 52801, US

(21) Appl. No.: 11/046,308

(22) Filed: Jan. 28, 2005

(51) Int. Cl. G09F 21/04

(52) U.S. Cl. 40/590

(57) ABSTRACT

A self-contained light system for installation of lights on trucks, all-terrain vehicles and pull-type farm equipment which increases visibility, allows compliance with the law, is inexpensive to manufacture and easy to install is described and claimed. The system and apparatus disclosed herein is adaptable to vehicles having hoist mounted beds. The fixed light mounting system disclosed allows the light assembly portion of the system to swing freely. Lights and signs mounted using the described apparatus may then swing to adjust to the change in the angle of the bed in relation to the ground as the bed is raised or lowered. The lights and signage continue projecting straight out from the box or bed improving visibility. The apparatus described may be adopted for off-road vehicles or farm implements to reduce damage to lighting systems upon impact with either the road or off-road materials propelled by the vehicle or equipment tires.

### CROSS REFERENCE TO RELATED APPLICATIONS

(Not applicable)

None

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND OF THE INVENTION

One object of the present invention is to improve the safety of drivers and people working in and around trucks having hydraulic hoist systems for tilting the box. For example, in the gravel, sand, dirt and grain hauling business, trucks mounted with a hydraulic hoist actuated box are common. Typically these trucks are known as dump trucks. The essential feature of these vehicles is that the trucks have a hydraulic system mounted in the undercarriage. The truck box sits on the frame of the truck. The truck box has a gate at the rear of the box. A hydraulic system, sometimes known as a hoist, is allowed to tilt the truck box up to ninety (90) degrees off of the truck frame. When the gate is open, the materials inside the box cannot resist the forces of gravity and are evacuated out the box through the open gate. The velocity of the evacuation and the type of materials in the box can produce a tremendous of dust, obscuring the vision of those around or approaching a truck. This is especially bad at night and made worst by the inherent design weaknesses of the box tail light assembly. The fixed position tail lights tilt down when the box is tipped up causing a downward projecting pattern of illumination. This downward projecting illumination pattern further obscures the box assembly to those around it.

A similar situation exists with the adoption by maintenance departments throughout the country of four-wheeled all-terrain vehicles in the last ten (10) years that have become almost ubiquitous. One of the original four-wheel all terrain utility vehicles is the “Gator” currently produced by John Deere. This vehicle, and similar models produced by companies such as Polaris and Kawasaki, have gained wide acceptance in the market. Hobbyists seeking outdoor recreation have adopted them for weekend fun. Farmers and ranchers have used them to survey the land and herd their animals. Maintenance groups have found the vehicles to provide a great way to haul tools and materials while navigating congested sprawling urban spaces. Although these vehicles come in many variations, similar to trucks, a recent innovation with this vehicle is the addition of the hoist mounted bed or box. This addition allows the user to place materials such as dirt or gravel in the back of the vehicle for easier dumping versus the standard frame fixed bed. More basic models allow the user to manually lift the box for dumping while higher end models allow actuation of hydraulics to tilt the box via a single lever or switch. These vehicles also need lights and warning signs to improve the safety of the user and those around him.

Another problem and potential application for the invention is also within the proceeding all-terrain vehicle market. Fixed mounted lights when exposed to the varying and often extreme conditions, to which operators subject the vehicles to, can be susceptible to violent interaction with branches, mud and rocks. Additionally, these vehicles may at times be placed in situations where rolling or tipping over is possible. This may occur if the operator attempts passage of an area not normally passable such as a steep hill or valley. As a result, the signage and or light mounting system may be exposed to forces in excess of what a fixed or stationary sign and light mounting system may be able to support with the attendant result being that metal, plastic and glass shatter, break and or bend, thus destroying or making the tail light and sign mounting system inoperable.

Another potential application for this invention is to farm equipment either pulled and or self-propelled. By law in some states, this equipment must have lights and a slow moving vehicle sign to be allowed access to major highways. Many times older equipment was manufactured and sold to farmers prior to enactment of these laws, thus the equipment it is not equipped with safety lights and proper safety signage. Another aspect of this problem is that even if the equipment was produced with the proper lights and safety signage, exposure to the elements and dirty environments is a difficult service at best for this equipment and can reduce the life span of the lighting and sign system originally mounted to the equipment. What is needed is a self-contained light and sign system for installation on trucks, all-terrain vehicles and farm equipment which increases visibility, allows compliance with the law, is inexpensive to manufacture and easy to install.

### BRIEF SUMMARY OF THE INVENTION

The invention as described herein is a system and method for securely mounting lights, light assemblies and safety signage to mobile vehicles or implements which allows both the light assembly portion of the mounting and the safety signage to swing freely. As described, the invention secures the light frame with a hinge allowing the lights to swing freely if pressure is put against either the lights or the sign.

The invention disclosed herein is also adaptable to vehicles having hoist mounted beds. When the hoist mounted bed is in the raised position, the lights swing to adjust to the change in the angle of the bed in relation to the ground as the bed is raised or lowered. The hinge based system therefore allows the lights and signage to continue projecting straight out from the box or bed. This improves the visibility of the vehicle to those working or interacting with vehicle. Additionally, the effective usable projected area of light around the vehicle is improved from the perspective of the vehicle user. The hinge mounted lighting and safety signage system thus improve both vehicle visibility and vehicle user illumination decreasing the safety hazards related to poor visibility and illumination.

It is therefore an object of the present invention to provide a fixed light mounting system that allows the lights assembly portion of the system to swing freely.

It is another object of the present invention to provide a light mounting system for mobile vehicles or farm equipment that reduces damage to the lights upon impact with either the road or off-road materials propelled by the vehicles tires.

It is another object of the present invention to provide a light mounting system that is useful in mounting to hydraulically actuated dump box systems.

It is another object of the present invention to provide an easy to use and mount system for attaching lights to four wheeled all-terrain vehicles.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1: Top view of hinge based light mounting system.

FIG. 2: Front view of hinge based light mounting system with lights and slow moving vehicle sign mount.

FIG. 3: Front view of hinge based light mounting system without taillights and with the slow moving vehicle sign mounted.

FIG. 4: Side view of hinge mounted light and sign system.

FIG. 5: Perspective view of hinge based light mounting system mounted on an all-terrain vehicle having a box hoist.

FIG. 6: Rear perspective view of hinge based light mounting system mounted on to an all-terrain vehicle having a box hoist.

FIG. 7: Front top perspective view of the hinge mounted lighting assembly in combination with an all-terrain vehicle having a hoist box.

### DETAILED DESCRIPTION OF THE INVENTION

### LISTING OF THE ELEMENTS

| Element Description | Element # |
|---|---|
| Hinge mounted light and signage system | 3 |
| Fixed hinge mount | 5 |
| Recesses in fixed hinge mount | 6 |
| Swingable hinge mount | 8 |
| Hinge | 10 |
| Butt end of Hinge | 15 |
| Front end of Hinge | 20 |
| Tail light holder | 25 |
| Tail light | 30 |
| Slow moving vehicle sign mount | 35 |
| Slow moving vehicle sign | 38 |
| All terrain vehicle | 40 |
| All terrain vehicle frame | 42 |
| All terrain vehicle box | 45 |
| All terrain vehicle box hoist | 50 |

### DETAILED DESCRIPTION

The present invention is more particularly described in the following exemplary embodiments that are intended as illustrative only since numerous modifications and variations therein will be apparent to those skilled in the art. As used herein, “a,” “an,” or “the” can mean one or more, depending upon the context in which it is used. The preferred embodiments are now described with reference to the figures, in which like reference characters indicate like parts throughout the several views.

As shown the hinges used in the various embodiments are of the continuous style. The leaf and pin of the hinges are made of steel. Although not shown, those practiced in the arts will understand that various types of hinges made of various materials may be used for different applications. For example, a counter-balanced hinge using a spring arrangement may be used in larger mounting systems to reduce the amount of free swing present in the system. Additionally, the cost and weight of the hinge system 3 could be reduced by making it from plastic or other non-ferrous materials.

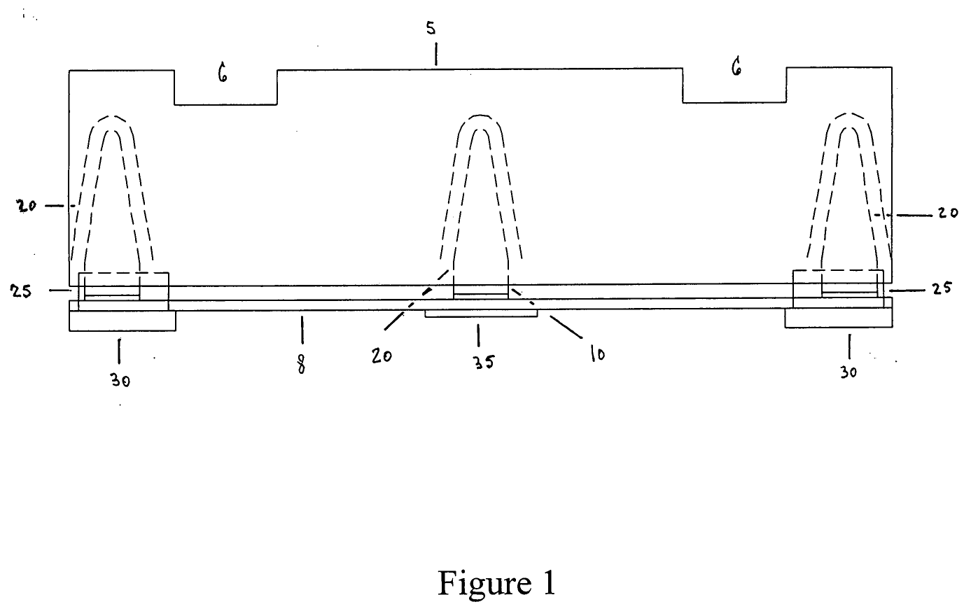

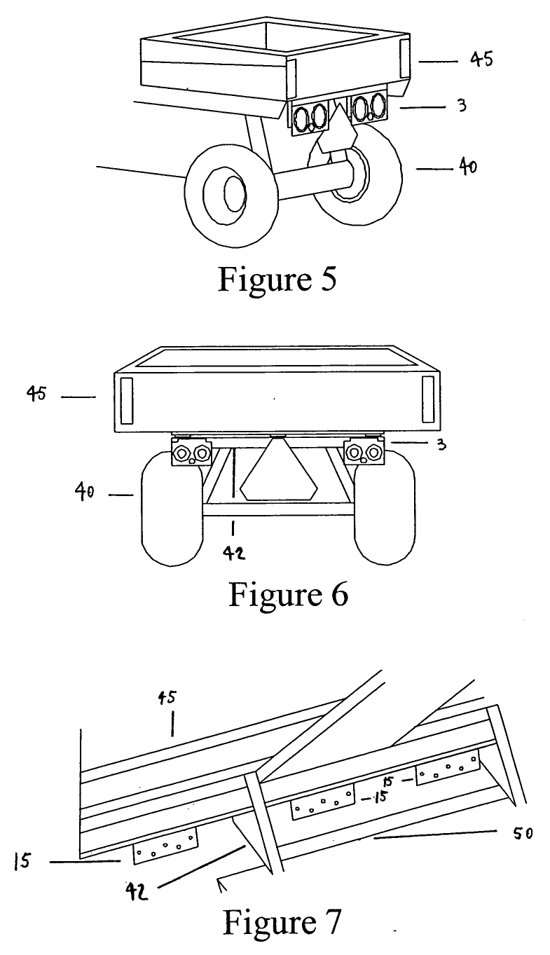

The embodiment shown herein uses what are sometimes referred to as “barn” hinges. The hinges 10 have a substantially flat lower surface for mating or engagement with a supporting surface. FIG. 1 presents a top view of the mounting system 3 with the hinges 10 shown mounted to the underside of the hinge mounting plate 5 and as represented by the hidden lines. As shown, the hinge mounting plate 5 is substantially a flat sheet of steel with recesses 6 cut into the sheet to allow the piece 5 to mount to the underside of the vehicle frame 42. See FIGS. 5-7. The embodiment shown in FIG. 1 is for mounting to an all-terrain vehicle 40 and has recesses 6 on the perimeter of the hinge mounting plate 5 to allow for the vehicle wheels or wheel wells. The hinges 10 are mounted on the opposite perimeter of the mounting plate 5 from the recesses 6. The number of hinges 10 and placement of the hinges 10 are selected to support the weight of the tail light holder 25, taillights 30 and slow moving vehicle sign mount 35 and sign 38. It will be clear to those practiced in the arts that the tail lights as shown do not include electrical wiring which must be added to power the lights and connected to the power generation or electrical system of the vehicle. The tail lights as shown may also be battery powered. In the figures shown, the electrical wiring has been removed to facilitate a clear presentation of the invention. It is contemplated that those practiced in the arts can add these necessary electrical components without further instruction from the inventor.

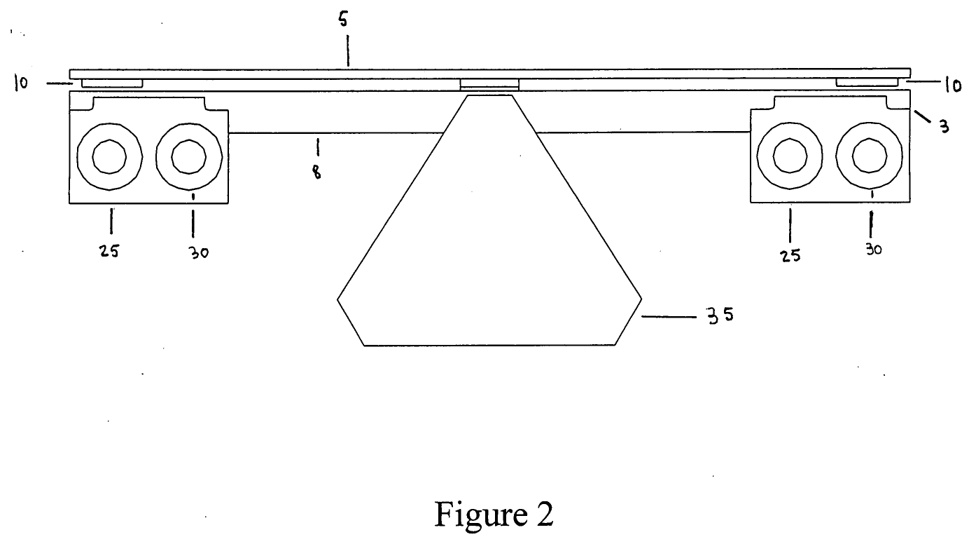

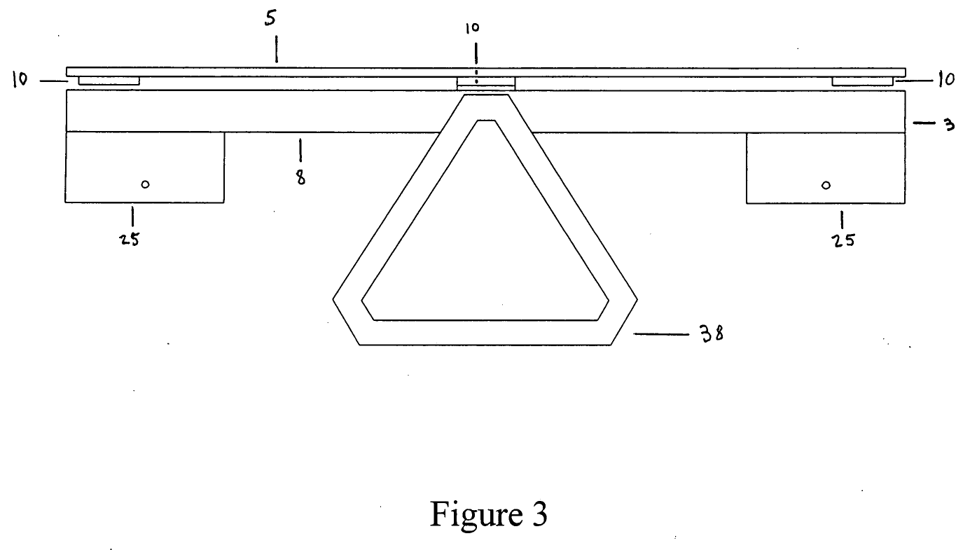

FIG. 2 illustrates a front view of the hinge based light mounting system 3 with the tail lights 30 and slow moving vehicle sign mount 35. The slow moving vehicle sign 38 was removed to better show the sign mount 35. This view shows that the swingable hinge mount 8 provides for equidistant spacing between the hinges as well as the sign 38 and tail lights 30. This increases the strength of the system and virtually eliminates the creation of unbalanced forces within the hinge system 3 and resultant wear and destruction. FIG. 3 provides another view of the hinge based light mounting system 3 but in this view the tail lights 30 are not shown to highlight the tail light mounting structure 25. Additionally, the slow moving vehicle sign 38 is shown mounted to the slow moving vehicle sign mount 35.

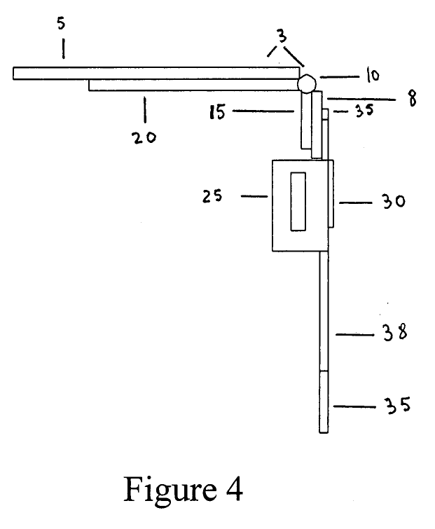

FIG. 4 provides a complete side view of the hinge system mounted sign and lighting system 3. The fixed hinge mount plate 5 is shown at the top with the front end of the hinge 20 mounted to the underside of fixed hinge mount plate 5. The butt end of the hinge 15 is shown mounted to the swingable hinge mount 8. The swingable hinge mount 8 provides a substantially vertical structure from which to attach the other components of the system, namely the tail light holders 25, tail lights 30 and slow moving vehicle sign 38 and mount 35. Mounting the lighting and signage to the swingable hinge mount 8 allows for easy adaption to any vehicle having a simple frame structure such as an all-terrain vehicle, a dump box truck or a farm implement.

FIGS. 5-7 show various views of the hinge based light and signage system 3 mounted on an all-terrain vehicle 40 having a box hoist 50. FIG. 5 provides a simple side perspective view. FIG. 6 provides a rear perspective view of the hinge based light and signage system 3 mounted on to an all-terrain vehicle 40 having a box hoist 45. FIG. 7 provides a front top perspective view of the hinge mounted light and signage system assembly in combination with an all-terrain vehicle 40 having a hoist box 50. In this figure, the swingable hinge mount 8 has been removed to better show the relationship between the hinges 10 and the underside of the hoist box 50. This figure particularly illustrates the adaptation of the system 3 to the frame of the all-terrain vehicle 42.

1. A swingable apparatus for fixed attachment to a wheeled vehicle comprising:
a. At least one hinge having front and butt ends;
b. A fixed hinge mount attachable to said vehicle, said front side of said hinge mounted to the underside of said fixed hinge mount; and,
c. A swingable hinge mount, said swingable hinge mount attached to said butt end of said hinge wherein a tail light system may be mounted to said swingable hinge mount.

2. The swingable apparatus according to claim 1 wherein further a sign may be mounted to said swingable hinge mount.

3. The swingable apparatus according to claim 1 and wherein further said vehicle is primarily for off-road use.

4. The swingable apparatus according to claim 3 and wherein further a sign may be mounted to said swingable hinge mount.

5. The swingable apparatus according to claim 1 and wherein further said vehicle is a pull-type farm implement.

6. The swingable apparatus according to claim 5 and wherein further a sign may be mounted to said swingable hinge mount.

7. A swingable apparatus for fixed attachment to a wheeled vehicle having a hoistable box comprising:
a. A set of three hinges, each of said hinges having front and butt ends;
b. A fixed hinge mount attachable to said vehicle, said front side of said hinges positioned substantially equidistant to said other hinges and fixedly mounted to the underside of said fixed hinge mount;
c. A swingable hinge mount; said swingable hinge mount attached to said butt end of each said hinge and wherein a tail light system may be mounted to said swingable hinge mount;
d. Said swingable apparatus may be connected to said vehicle power system for electrification and control of said tail light system; and,
e. Said swingable apparatus allows the tail light system to respond to the change in angle and elevation of said vehicle hoistable box during hoisting operation.

8. The swingable apparatus according to claim 7 wherein further a sign may be mounted to said swingable hinge mount.

9. The swingable apparatus according to claim 8 wherein further said sign is a slow moving vehicle sign.

10. The swingable apparatus according to claim 7 wherein said vehicle is a farm implement.
